(19) United States
(12) Patent Application Publication
(10) Pub. No.: US 2011/0209772 A1
(43) Pub. Date: Sep. 1, 2011

(54) IN-LINE TREBLE-PORT VENTURI CONNECTOR WITH SUPPLEMENTAL INLET PORT AND LOW FLOW BAFFLE

(76) Inventors: Dale William Woiken, Upland, CA (US); Matthew John Jaggers, Riverside, CA (US); Jerry R. Eatmon, La Miranda, CA (US); Douglas A. Bjork, Crestline, CA (US); Richard Woiken, Rancho Cucamonga, CA (US); William H. Marcel, Long Beach, CA (US)

(21) Appl. No.: 13/031,124

(22) Filed: Feb. 18, 2011

Related U.S. Application Data
(60) Provisional application No. 61/305,786, filed on Feb. 18, 2010.

(51) Int. Cl. F15D 1/00; F16L 9/22; F16L 41/00

(52) U.S. Cl. 137/15.01; 138/155; 285/122.1

(57) ABSTRACT

An in-line treble port venturi connector provides a low flow, low pressure inlet port for drawing supplemental fluid into a main flow path. The connector includes a main flow tube having a mixing channel restricting flow and lowering pressure between an upstream port and a downstream port. A baffle projects into the main flow tube from the inner surface of the mixing channel at a location upstream of an inlet port, obstructing main flow to create a separation zone in the low pressure area, causing rotational flow within the separation zone and lowering the average flow rate in the direction of main flow. A pressure differential allows supplemental fluid to be drawn into the mixing channel through the inlet port. The connector may be used to introduce hydrogen or oxygen gas from an on-board generator into a main flow of hydrocarbon fuel in the intake manifold of an internal combustion engine.

This invention claims priority to U.S. Provisional Application No. 61/305,786, which was filed Feb. 18, 2010, and which is fully incorporated herein by reference.

### BACKGROUND OF THE INVENTION

1. Field of the Invention

The present invention relates generally to pipe connectors, more specifically to venturi connectors, and most specifically to an in-line treble-port venturi connector having a low flow, low pressure inlet port for drawing supplemental fluid into a main flow path.

2. Description of Related Art

Venturi tubes are used for a variety of applications in fluid systems. Generally, a venturi tube or venturi operates by restricting a flow path, for example, by narrowing a section of pipe from a large diameter to a smaller diameter. According to the Bernouli principle, as flow velocity increases through the restriction, it creates a corresponding drop in fluid pressure. It is well known to exploit this principle by connecting pressure gauges at both the large and small diameter portions of the pipe to detect a pressure differential from which a measurement of fluid velocity or flow rate may be derived.

Another application of the Bernouli principle may be found in the design of a carburetor. In a carburetor, a first fluid, such as fuel, may be introduced into the main flow of a second fluid, such as air, by directing the flow of the second fluid through a venturi in the main flow path. An inlet for the first fluid may be connected to the venturi at the restriction area, so that when the second fluid gains sufficient velocity through the restricted area, the corresponding pressure drop draws the first fluid into the main flow path. See, e.g. V. Ostdiek et al., Inquiry Into Physics, pp. 160-162, 1987.

The carburetor has been used throughout the twentieth century as a means for mixing a hydrocarbon fuel (such as gasoline) with air drawn into the intake manifold of an internal combustion engine. More recently, the applicants of the present invention have investigated the feasibility of supplementing the hydrocarbon fuel in an internal combustion engine of a vehicle with hydrogen and/or oxygen generated on board the vehicle through electrolysis of water or other means. The hydrogen/oxygen gas stream is usually only a fraction of a percent of the intake combustion air flow but experimental evidence shows that this small stream can reduce emissions of particulates from diesel engines and in some cases also reduce emissions of NOx and provide small increases in engine fuel efficiency. On-board hydrogen/oxygen generators are typically water electrolyzers powered by electrical current from the vehicle battery or alternator and are fitted to the rear of the cab compartment of a truck or under the hood of a car.

For the present inventors, a design objective for an on-board hydrogen/oxygen generator is the minimization of cost and complexity through the use of passive controls. The problem being solved by the present invention is how to introduce a supplemental flow of hydrogen or oxygen into the airstream of an intake manifold of an internal combustion engine using passive controls.

### SUMMARY OF THE INVENTION

The present invention provides an engineering design for an in-line treble port venturi connector that provides a low flow, low pressure inlet port for drawing supplemental fluid into a main flow path. The invention also pertains to a method for creating the low flow, low pressure inlet port. One application for the invention is in conjunction with an on-board hydrogen generator for a vehicle, wherein the connector may be used to introduce hydrogen and/or oxygen gas from the generator as a fuel supplement into a main flow of hydrocarbon fuel in the intake manifold of an internal combustion engine.

In one embodiment, the invention provides an in-line treble-port venturi connector. The connector includes a main flow tube having a mixing channel bordered by an upstream port and a downstream port, the upstream port having an inner diameter greater than an inner diameter of the mixing channel. An inlet port is provided in fluid communication with the mixing channel, and a baffle is provided that projects into the main flow tube from the inner surface of the mixing channel at a location upstream of the inlet port. By immersing the connector within flow of a main fluid to direct a portion of the main fluid through the upstream port, the portion of main fluid that flows into the mixing channel will increase in velocity and decrease in pressure according to the Bernouli principle. The baffle obstructs part of the flow to create a separation zone within the area of decreased pressure and to cause rotational flow in the separation zone so that within the separation zone the average flow rate in the direction of main flow is less than main fluid flow rate around the separation zone. The connector is configured to create the separation zone adjacent to the inlet port, so that supplemental fluid at a higher pressure may be introduced into a low pressure area of the mixing channel at a low flow relative to the main flow. Rotational flow induced in the supplemental fluid assists in mixing the supplemental fluid into the main flow downstream of the connector.

More elaborate embodiments of a connector according to the invention include variations in the shape of the baffle, various means for connecting the supplemental fluid to the inlet port, and various means for anchoring the connector to the wall of a conduit carrying the flow of main fluid.

A method according to the invention for providing low flow, low pressure inlet for introducing supplemental fluid into a flow of main fluid includes the following steps: (i) immersing a treble-port venturi within the flow of main fluid to direct a portion of the main fluid flow through the venturi, the venturi having an upstream port, a mixing channel, and a downstream port, the upstream port having an inner diameter greater than an inner diameter of the mixing channel and the mixing channel having an inlet port for supplemental fluid, (ii) connecting the inlet port to a supply of the supplemental fluid external to the main fluid flow, and (iii) obstructing the portion of main fluid flow through the venturi upstream of the inlet port to create a separation zone adjacent to the inlet port. The method may also include a step for maintaining pressure of the supplemental fluid greater than pressure in the separation zone, and a step for maintaining pressure of the supplemental fluid less than pressure in the main fluid outside of the venturi connector.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a perspective view of one embodiment of a treble-port venturi connector according to the invention installed within a section of main flow conduit for introducing a supplemental flow into the main flow conduit.

FIG. 2 is a perspective free-body view of the venturi connector of FIG. 1.

FIG. 3 is a front view of one embodiment of a treble-port venturi connector according to the invention.

FIG. 4 is a left side view of the venturi connector of FIG. 3.

FIG. 5 is a front cross sectional view taken along section A-A of the venturi connector of FIG. 4.

FIG. 6 is a bottom view of the venturi connector of FIG. 3.

FIG. 7 is an inverted cross sectional left side view taken along section B-B of the venturi connector of FIG. 6.

FIG. 8 is a right side view of the venturi connector of FIG. 3.

FIG. 9 is a top cross sectional view taken along section C-C of the venturi connector of FIG. 8.

FIG. 10 is a magnified top view of an in-line treble-port venturi connector according to one embodiment of the invention, showing a separation zone created in the mixing chamber immediately downstream of the baffle and adjacent to the inlet port.

FIG. 11 is a magnified side view of the connector of FIG. 10, showing both main and supplemental flow patterns in and around the mixing chamber.

FIGS. 12-16 each show top and side views of different embodiments of a baffle for use in an in-line treble-port venturi connector according to the invention.

FIG. 17 shows a cross-sectional side view of an inlet tube for introducing supplemental fluid into a main fluid flow according to the invention.

FIG. 18 shows a cross sectional rear view of the inlet tube of FIG. 17, obtained by rotating the inlet tube 90 degrees.

### DETAILED DESCRIPTION OF THE INVENTION

The following disclosure presents an exemplary embodiment of the invention for a treble-port venturi connector for introducing supplemental flow into a main flow. The venturi connector is designed for immersion within a flow path of a main fluid, and for directing the supplemental flow into a low pressure separation zone created within the venturi connector.

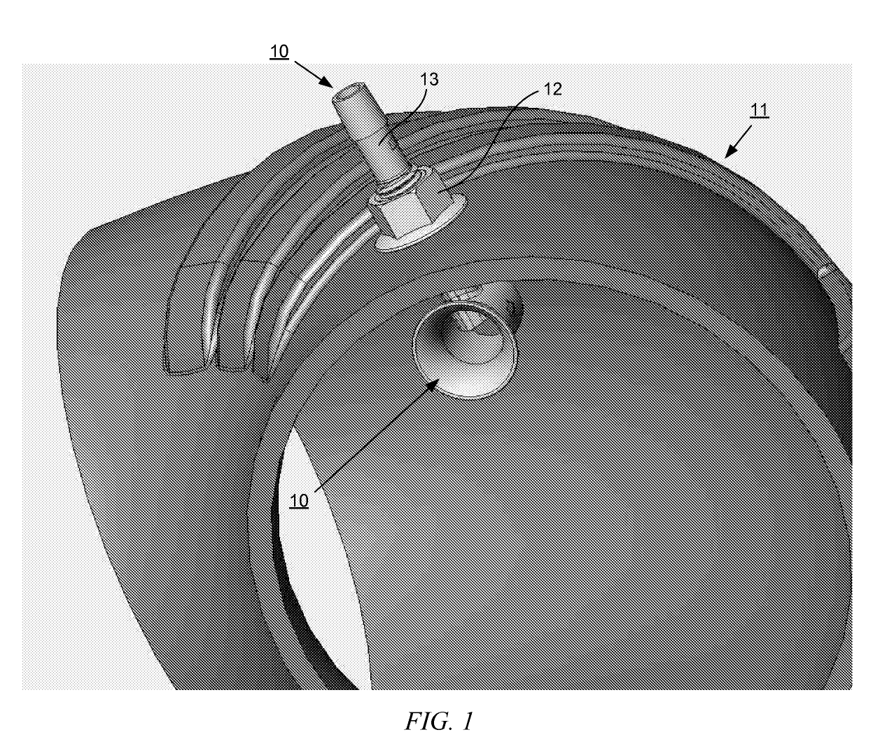

FIG. 1 shows an exemplary embodiment of a three-port venturi connector 10 installed within a section of main flow conduit 11. The connector 10 may include fastening hardware 12 for fixing the connector to a wall of the conduit 11, as shown. Conduit 11 may be a rigid rubber or metal pipe section that forms part of the intake manifold for an internal combustion engine, such as a diesel or gasoline engine. In this example, fastening hardware 12 comprises a hex nut and washer. The hex nut may be tightened against an outer wall of conduit 11 by exterior threading on an inlet tube 13 that extends from connector 10 through the outer wall of the conduit. When fastened properly into position, the venturi connector 10 is oriented as shown so that its upstream port is aligned to receive a portion of a main fluid flowing through conduit 11. In FIG. 1, the direction of main flow is into the page, and the direction of supplemental flow through inlet tube 13 is into the main flow conduit.

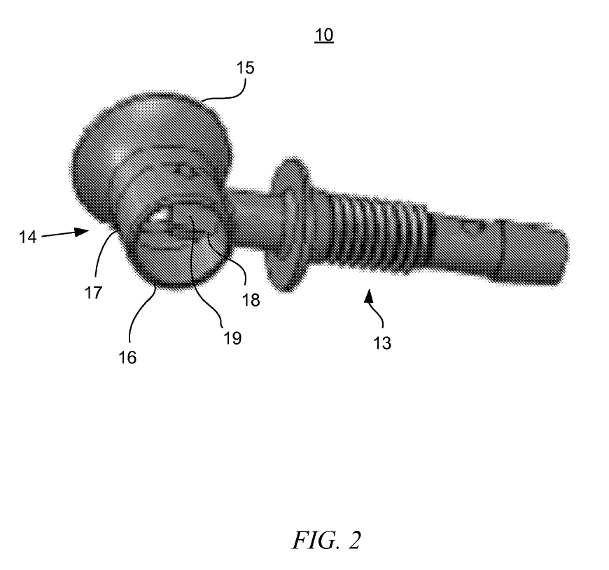

FIG. 2 shows a perspective free-body view of a venturi connector 10 according to one embodiment of the invention. Connector 10 generally comprises an inlet tube 13 and a main flow tube 14. The main flow tube 14 has an upstream port 15, a downstream port 16, and a mixing channel 17 extending between the upstream and downstream ports. To create the venturi effect, the inner diameter of the main flow tube at the upstream port 15 is greater than the inner diameter of the mixing channel 17. The inlet tube 13 connects to the mixing channel 17 to allow a supplemental fluid to flow into the main flow tube through an inlet port 18. A baffle 19 is shown projecting into the main flow tube from an inner surface of the mixing channel. The baffle 19 is located upstream of the inlet port 18, for example, between the upstream port 15 and an upstream edge of the inlet port 18.

The connector 10 may be formed from a single rigid material, such as a metal or thermoset plastic, and it may be molded, cast, or machined, or formed by some combination of molding, casting, and machining. In another embodiment, the connector 10 may be composed of two or more parts that are welded together, or from two or more parts that are fastened together, for example, by threaded connection.

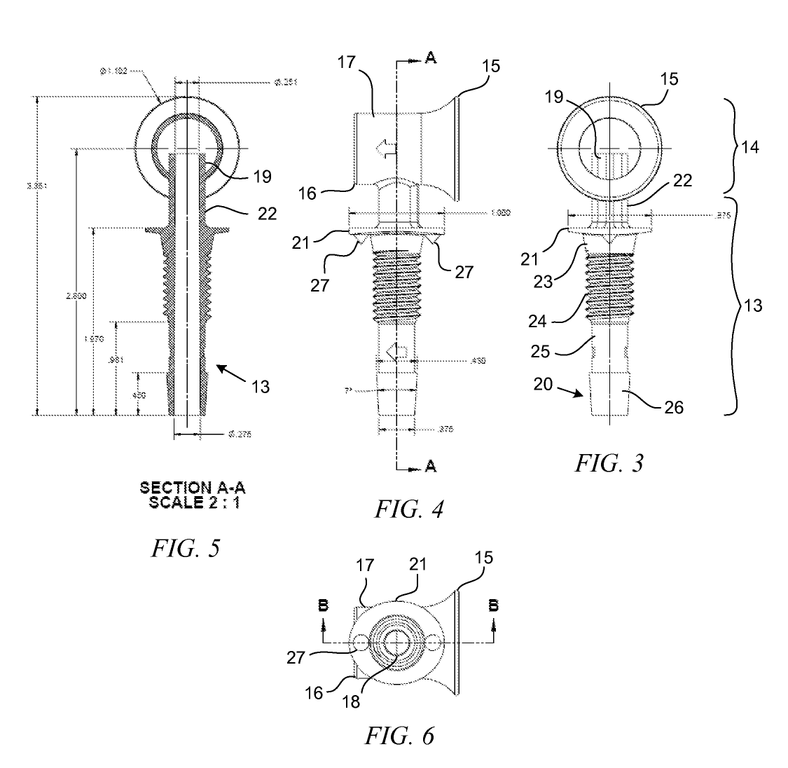

FIG. 3 shows a front view of one embodiment of a treble-port venturi connector according to the invention. In this view, the upstream port 15 is nearest the page, and in the preferred operating orientation, flow of a main fluid would enter the main flow tube 14 through the upstream port in a direction normal to the upstream port and into the page. Inlet tube 13 is shown extending downward from the bottom center of the main flow tube 14. The baffle 19 can be seen projecting upward into the interior of the main flow tube to partially obstruct flow therethrough. In one embodiment, baffle 19 may be formed from the same material used to form the inlet tube 13. In another embodiment, the baffle 19 may project into the main flow tube for a distance that is less than half the inner diameter of the main flow channel. In other words, the baffle may rise to an elevation below the midpoint of the main flow tube. In other embodiments, the baffle may rise higher than the midpoint of the main flow tube.

Inlet tube 13 may extend from an inlet port in the main flow tube 14 to a connecting end 20. An anchoring flange 21 may be connected to the inlet tube 13 between the connecting end 20 and the inlet port. In one embodiment, the anchoring flange may project radially outward from the inlet tube, as shown. The anchoring flange 21 may be displaced from the main flow tube by a length of inlet tube called the insertion length 22. When installed, the anchoring flange 21 may abut an inner wall of a main flow conduit (such as main flow conduit 11), thereby displacing the main flow tube 14 from the inner wall of the main flow conduit by a distance determined according to the insertion length 22.

On the opposite side of the anchoring flange, the inlet tube 13 may also provide a tapered portion 23. Tapered portion 23 may extend from the lower surface of the anchoring flange, i.e. the surface that faces away from the main flow tube, toward the connecting end 20. In one embodiment, the tapered portion 23 has a maximum diameter at the anchoring flange, tapering to a minimum diameter as it approaches the connecting end.

In the embodiment of FIG. 3, the tapered portion 23 extends to a threaded portion 24 of inlet tube 13. The threads of threaded portion 24 may be a standard pitch pipe thread, disposed on an outer diameter of the inlet tube. The threaded portion 24 may extend to a clamping portion 25. In one embodiment, clamping portion 25 has a constant outer diameter. The clamping portion 25 may extend to a tubing barb 26, which forms the connecting end 20 of the inlet tube. The tubing barb 26 may be tapered, as shown, to facilitate insertion within a conduit (such as a rubber hose) leading to a source of supplemental fluid. Where the tubing barb meets the clamping portion, the diameter of the tubing barb may slightly exceed the diameter of the clamping portion so that when the rubber hose is drawn over the tubing barb, a hose clamp may be used to clamp the hose to the clamping portion 24 and seal the hose against the large diameter end of the tubing barb.

FIG. 4 shows a left side view of the venturi connector of FIG. 3. In this embodiment, the mixing channel 17 has inner and outer diameters equal to the inner and outer diameters of the downstream port 16. This view shows the inlet tube 13 extending from the mixing channel at a location that is about midway between the upstream and downstream ports. A pair of anchoring spikes 27 are shown projecting away from the lower surface of anchoring flange 21. These anchoring spikes, or anti-rotational locks, are provided as a means for preventing the connector from rotating during installation.

For example, one method of installing the connector 10 is to drill or tap an installation hole into an uninstalled section of main flow conduit. Preferably, the section of main flow conduit is formed from a slightly resilient material such as a hard rubber. The installation hole should be slightly smaller in diameter than the inner diameter of the threaded portion 24. The connecting end 20 of the connector 10 may then be pushed or rotated through the installation hole from inside the section of main flow conduit until the lower part of the tapered portion 23 reaches the installation hole. At this point, fastening hardware, such as a washer and hex nut, may be respectively placed and threaded onto the threaded portion 24 from outside the conduit section. By tightening the nut onto threaded portion 24, the tapered portion 23 will be drawn further into the installation hole to form a tight seal with the conduit section. As the nut is tightened further, the lower surface of the anchoring flange 21 will abut the inner wall of the conduit section, and the anchoring spikes 27 will begin to contact the inner wall. At this point, connector 20 may be oriented so that the upstream port faces the direction of incoming flow through the main flow conduit. As the nut continues to tighten, the anchoring spikes will dig into the inner wall of the conduit section and prevent rotation of the connector. The nut may then be tightened to a desired torque.

FIG. 5 shows a front cross sectional view taken along section A-A of FIG. 4. Dimensions shown in this and other figures are provided only for purposes of illustration, and are not intended to limit the invention. In this view, the baffle 19 is shown having a width equal to the outer diameter of insertion length 22, and the inner diameter of inlet tube 13 is constant along its entire length. In this embodiment, the inner diameter of the mixing channel is constant and equivalent to the inner diameter of the downstream port.

FIG. 6 shows a bottom view of the venturi connector of FIG. 3. In this view, anchoring flange 21 is shown having a generally oval or elliptical shape to accommodate anchoring spikes 27, which may be located on opposing ends of the flange along the transverse diameter of the ellipse. Inlet port 18 is shown comprising a hole formed in a lower wall of the mixing channel 17.

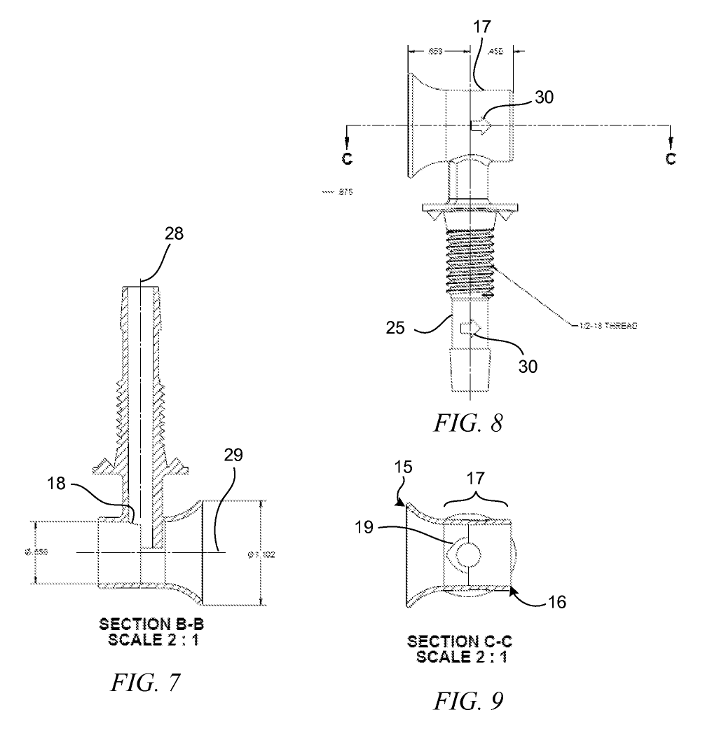

FIG. 7 shows an inverted cross sectional right side view taken along section B-B of the venturi connector of FIG. 6. In this view, inlet port 18 is shown oriented so that the central axis 28 of the inlet port intersects the central axis 29 of the mixing channel.

FIG. 8 shows a right side view of the venturi connector of FIG. 3. As in FIG. 3, there are two arrows 30 shown on the connector, one on the outer wall of mixing channel 17 and another on the outer wall of clamping portion 25. The arrows 30 indicate the direction of main fluid flow through the connector 10. The arrows may be physically formed at any convenient location on the connector, for example, by molding, printing, engraving, or etching, for use as an orientation guide when installing the connector in a main flow conduit.

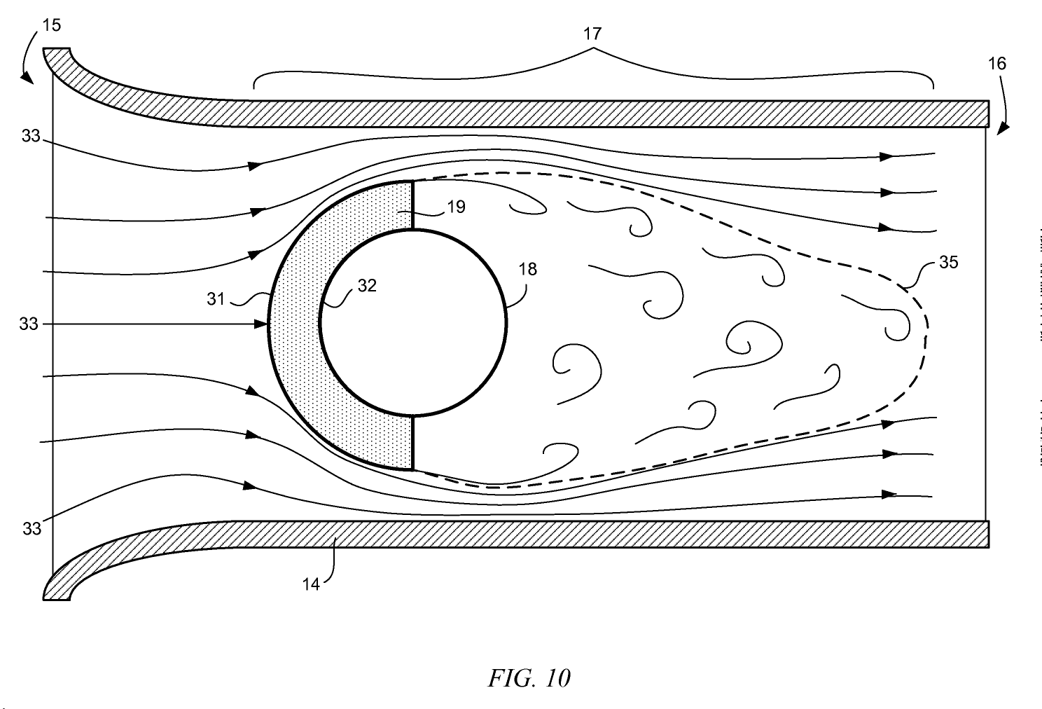

FIG. 9 shows a top cross sectional view taken along section C-C of the venturi connector of FIG. 8. This view illustrates an embodiment of the connector wherein both the inner and outer diameters of the main flow tube are gradually contoured from the upstream port 15 to the upstream end of the mixing channel 17. The upper end of baffle 19 is shown more clearly in the magnified view of FIG. 10.

FIG. 10 is a magnified top view of a venturi connector according to one embodiment of the invention. This figure shows inlet port 18, baffle 19, and a separation zone 35 created in the mixing chamber 17 immediately downstream of the baffle and adjacent to the inlet port when a main fluid flows through the connector. Baffle 19 may be configured as shown so that it provides an outer wall 31 and an inner wall 32. The main flow is indicated by flow lines 33 which enter the connector through the upstream port 15. In one embodiment, the outer wall 31 is oriented substantially normally to the direction of main flow through the main flow tube from the upstream port 15 to the downstream port 16.

Flow entering the upstream port is ideally irrotational. As the main flow enters the connector, it accelerates through the venturi restriction and impacts the outer wall 31, which diverts the flow over and around the baffle. In an area directly downstream of the baffle 19, the obstruction of the baffle creates a separation zone 35. The dashed line indicates, approximately, the boundary of the separation zone. A portion of the main flow continues around the separation zone as irrotational flow. Within separation zone 35, however, portions of the fluid separate from the irrotational flow channels and enter the separation zone, forming vortices characterized by rotational flow patterns. The shape of the separation zone and the flow characteristics therein are determined by a number of factors, including the Reynolds number, the geometry of the channel, the shape of the baffle, and the roughness of the outer wall. See, e.g., Roberson, et al., Engineering Fluid Mechanics, 3^{rd} Ed., pp. 158-162, 1985.

In FIG. 10, a separation point 34 is indicated near the downstream end of the outer wall 31 of baffle 19. This point provides an approximate location of the furthest point upstream where the separation begins. It is well known in fluid mechanics that the pressure that prevails at the point of separation prevails over the body of fluid within the separation zone. It is also possible to design for pressure at point 34 by constructing a venturi restriction according to the invention, taking into account both the restriction of the mixing channel 17, and the restriction introduced between the outer wall 31 of baffle 19 and the inner wall of the mixing channel.

In a connector according to the present invention, three concepts are combined: (i) the concept of a venturi restriction to determine pressure at point 34, (ii) the concept of creating a separation zone 35 through which the pressure at point 34 prevails, and (iii) the treble-port configuration whereby the inlet port 18 opens into the separation zone 35 downstream of baffle 19. By this novel design, supplemental fluid that is maintained at a higher pressure than the pressure in the separation zone may enter the mixing channel through the inlet port into a volume of rotational flow. Because pressure in the separation zone is lower than pressure in the main flow outside of the connector, the Bernouli principle requires that flow velocity in the separation zone be greater than main flow velocity outside the connector. However, because the flow within the separation zone is rotational, the Bernouli principle is satisfied by higher angular velocities of fluid rotating as vortices within the separation zone. Some of the kinetic energy of the fluid within the separation zone will be dissipated as heat. In aggregate, the average flow velocity in the separation zone in the direction of main flow from the upstream port to the downstream port will be lower than the flow velocity of irrotational fluid flowing around the separation zone (i.e. the irrotational flow indicated by the paths of upper and lower flow lines 33). The overall result is that a treble-port venturi connector according to the invention creates a low pressure, low flow entry point for introducing a supplemental fluid into a main flow path. This concept is counter-intuitive to engineers designing systems according to the Bernouli principle, which associates low pressure with high flow and vice versa.

One advantage of a treble-port venturi connector of the present invention is that it allows a supplemental fluid to be introduced into a main flow path in a more controllable fashion. For example, parameters such as the geometry of the flow channels and baffle, the main fluid flow rate, and the supplemental fluid pressure, may be determined so that the supplemental fluid flow may be passively controlled. An ideal mixture of two fluids, for example, a main flow of hydrocarbon fuel and a supplemental flow of hydrogen, may be obtained thereby. A further advantage of the invention is that configuration of the connector causes rotational flow of supplemental fluid as it enters the inlet port. The rotational flows or whirlpools of supplemental and main fluids improve the homogeneity of the mixture as it progresses downstream. Yet another advantage of the present invention is that it allows the supplemental fluid to be maintained at a lower pressure than the normal pressure of the main fluid. This has particular significance in applications for on-board hydrogen generators. For safety reasons, it preferable not to maintain hydrogen gas in a highly pressurized state on board a passenger vehicle.

FIG. 11 shows a magnified side view of the venturi connector of FIG. 10. In particular, the figure illustrates flow of main and supplemental fluids through the mixing channel 17. Main fluid flow is indicated by flow lines 33, which enter the connector though the upstream port. A portion of the main fluid flow impacts baffle 19, then rises above and around the baffle, creating a separation zone 35. Supplemental flow 34 enters into the separation zone from inlet port 18. The rotational flow of main fluid within the separation zone 35 induces rotational flow in the supplemental fluid, as shown. The restricted flow path through the mixing channel combined with the separation zone downstream of the baffle provides a low pressure, low flow inlet port for the supplemental fluid.

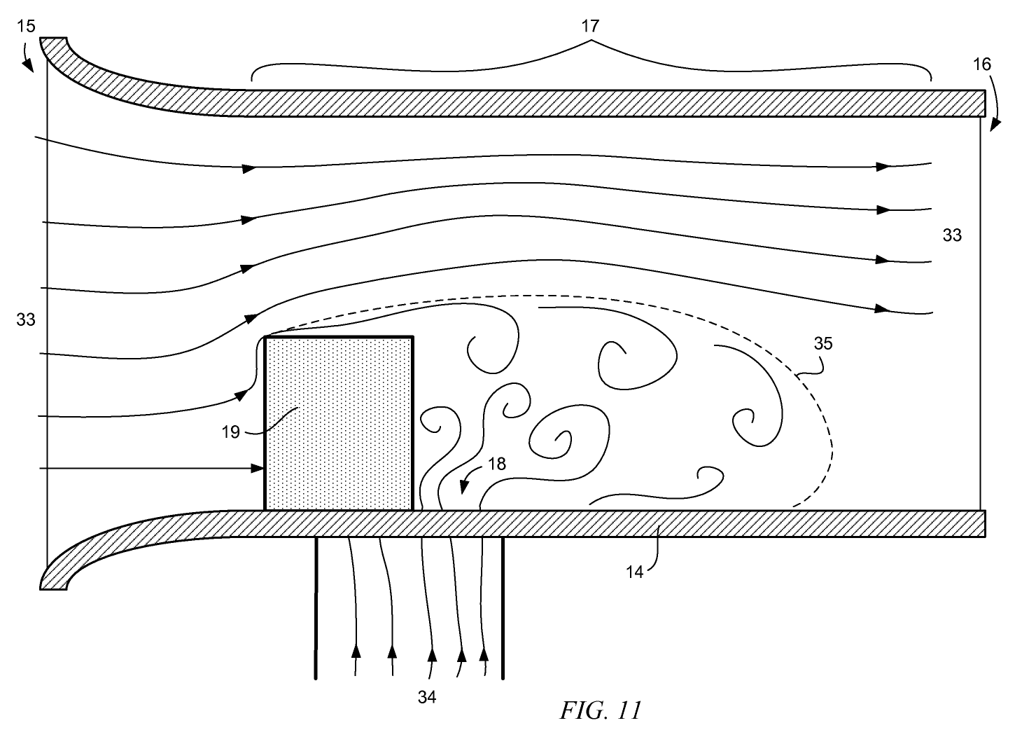

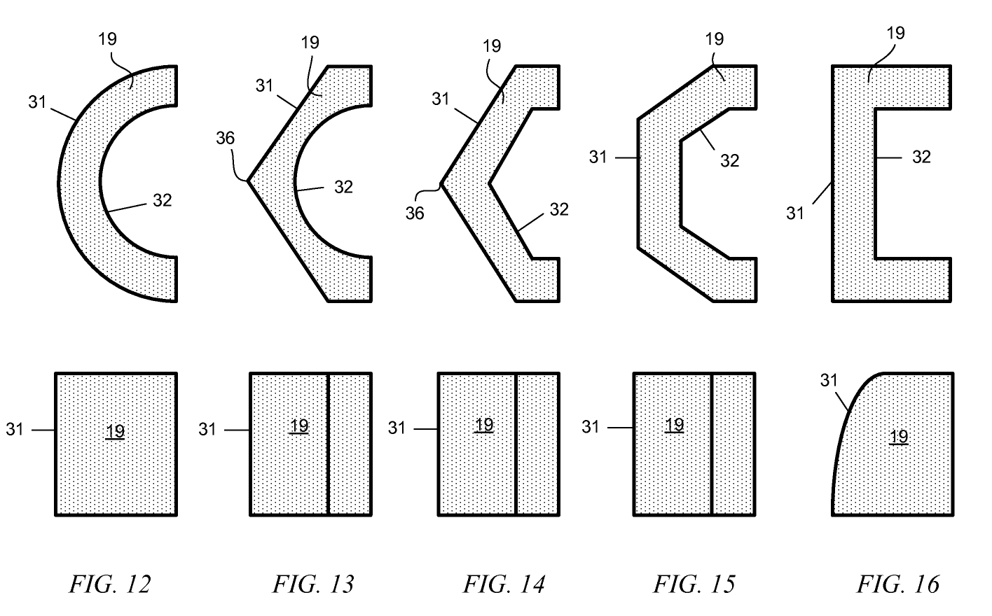

Various configurations of a baffle 19 are possible within the scope of the invention. FIGS. 12-16 illustrate some of these. Each figure shows top and side views of a variation in baffle design. In one embodiment, as shown in FIG. 12, the outer wall 31 and inner wall 32 may each comprise a semi-circular arch. In another embodiment, as shown in FIG. 13, the outer wall 31 may comprise one or more substantially planar walls, and the inner wall 32 may comprise a semicircular arch. In the embodiments of FIGS. 13 and 14, the outer wall 31 may comprises two substantially planar walls that meet along a leading edge (i.e. an upstream edge) of the baffle 19, such that the leading edge is proximal to the upstream port of the connector. The two substantially planar walls may meet at a central location 36 on the upstream side of the inlet port. In other embodiments, the substantially planar outer walls may have different widths, and the leading edge may be non-centrally located. In another embodiment, the inner wall 32 may comprise a contoured wall aligned with a contour of the inlet port 18, as shown in FIGS. 12 and 10. In the embodiments of FIGS. 14 and 15, both the outer wall 31 and the inner wall 32 comprise more than one substantially planar wall. The baffle of FIG. 15 provides a central portion of the outer wall 31 that is oriented substantially normally to the direction of main fluid flow. The baffle of FIG. 16 provides a single outer wall 31 that is substantially normal to the direction of main fluid flow, and also slopes gradually upward toward the middle of the flow tube when viewed from the side. According to the invention, there are many other possible baffle designs that incorporate curved surfaces, planar surfaces, and combinations thereof for obstructing flow through the connector.

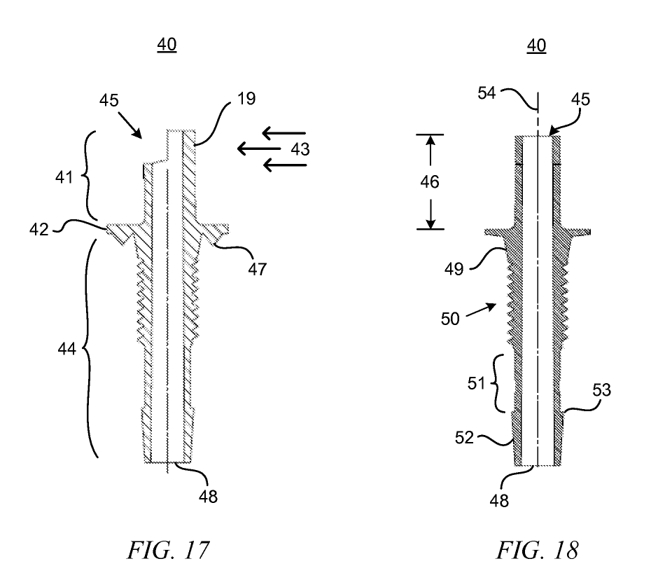

FIGS. 17-18 show an embodiment of the invention for introducing a supplemental fluid flow into a main fluid flow within a main flow conduit by means of an inlet tube 40. FIG. 17 shows a cross-sectional side view of the inlet tube 40 to best illustrate the configuration of a baffle 19. In FIG. 17, the inlet tube is positioned within a main flow conduit (not shown) so that the direction of main flow 43 through the main conduit impacts the baffle 19 at an angle substantially normal to the baffle surface. FIG. 18 shows a cross sectional rear view of the inlet tube 40, obtained by rotating the inlet tube 90 degrees to the right so that the flow lines 43 would emerge from the page. Materials of construction of the inlet tube 40 may be metal or plastic, similar to those disclosed for manufacturing the connector 10. As such, the inlet tube 40 may be formed by molding, casting, machining, or by some combination of these, from a single piece of material of using two or more component parts to form the whole.

This embodiment of inlet tube 40 may be considered similar to connector 10 but with the main flow tube 14 removed. Inlet tube 40 may be substantially cylindrical, and includes an insertion end 41, and anchoring flange 42, and a connecting end 44. The insertion end 41 defines an outlet port 45 as an opening in the insertion end to allow passage of supplemental fluid, such as hydrogen or oxygen gas, from the tube and into the main flow 43. The baffle 19 may be formed at the insertion end 41 so that it extends the insertion end 41 beyond the outlet port 45 on one side of the outlet port, as shown. In one embodiment, the baffle 19 may be formed as a partial circumferential extension of the insertion end beyond the outlet port 45, and in another embodiment, the partial circumferential extension may be formed as a semi-cylindrical extension of the main cylindrical portion of the inlet tube.

The anchoring flange 42 projects from an outer wall of the inlet tube 40 radially outward with respect to an imaginary longitudinal axis running vertically through the center of the tube. One or more anchoring spikes 47 may be disposed on a lower surface of the anchoring flange 42, that is, the surface facing away from the insertion end 41, as shown. The pointed end of each anchoring spike 47 protrudes a short distance from the flange surface and is designed to penetrate (but not perforate) an inner wall of the main flow conduit when the inlet tube is clamped thereto, to anchor the tube to the conduit and prevent rotation or slippage of the tube.

The anchoring flange 42 may be displaced from the outlet port by an insertion length 46. The insertion length 46 may be defined as length the positions the outlet port 45 at an approximate center of main flow 43 when the inlet tube 40 is anchored to a main flow conduit. In one embodiment, an apparatus according to the invention may include a portion of a main flow conduit, such as a rubber boot or rubber hose connection, with the inlet tube 45 installed. An inlet tube so installed means that it is fully clamped to opposing sides of a wall of the main flow conduit with the anchoring spikes 47 engaging the inner wall.

The connecting end 44 extends from the lower surface of the anchoring flange 42 and terminates at an inlet port 48. In one embodiment, the connecting end 44 may include a tapered circumferential portion 49 located adjacent to the lower surface of the anchoring flange 42, as shown. A threaded circumferential portion 50 may extend along the outside surface of the tube from the tapered circumferential portion 49 to a clamping length 51. The clamping length provides sufficient surface area to allow a hose clamp to connect and seal a plastic or rubber supply tube to the connecting end. The clamping length 51 may extend from the threaded circumferential portion to a tubing barb 52. The tubing barb may provide a tapered portion that tapers from a maximum diameter at the junction with the clamping length, to a minimum diameter at the inlet port 48. An abrupt edge 53 may be formed at the junction with the clamping length to create the seal when the supply tube is clamped along the clamping length 51.

When the inlet tube 40 is installed in a main flow conduit so that the baffle 19 is located approximately in the center of main fluid flow, a separation zone will form downstream of baffle 19. The separation zone will exhibit flow characteristics similar to those described in the context of connector 10 and shown in FIGS. 10 and 11. Rotational flows created within the separation zone will help to mix supplemental fluid with the main fluid, where the supplemental fluid is introduced into the main flow via the inlet tube 40.

When installing the inlet tube 40 within a section of main flow conduit, it may be helpful to include a visual indicator on the connecting end 44 that indicates the proper orientation of the inlet tube 40 with respect to the direction of main fluid flow. For this purpose, to indicator such as an arrow or other directional marker (see, e.g. arrow 30 in FIG. 8) may be formed on the outer wall of the tube anywhere along the length of the connecting end 44. In another embodiment, the clamping length 51 may form a 90 degree bend or elbow that places the tubing barb 52 in an orientation perpendicular to the longitudinal axis 54 of the inlet tube. The right-angled tubing barb 52 may extend in a direction parallel to a line that is normal to baffle 19, such as a flow line 43. This configuration would, in FIG. 17, result in the inlet port 48 facing to the left of the page, and in FIG. 18 would result in the inlet port 48 facing out of the page. During installation, and prior to clamping the inlet tube 40 to the main flow conduit, the installer could ensure proper orientation of the baffle 19 within the main flow conduit according to the orientation of the right-angle tubing barb.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. An in-line treble-port venturi connector, comprising:
a main flow tube having a mixing channel bordered by an upstream port and a downstream port, the upstream port having an inner diameter greater than an inner diameter of the mixing channel;
an inlet port in fluid communication with the mixing channel; and
a baffle projecting into the main flow tube from the inner surface of the mixing channel at a location upstream of the inlet port.

2. The connector of claim 1 wherein the inner diameter of the upstream port contours gradually to the inner diameter of the mixing channel.

3. The connector of claim 1 wherein the inner diameter of the mixing channel is constant.

4. The connector of claim 3 wherein the downstream port has an inner diameter equal to the inner diameter of the mixing channel.

5. The connector of claim 1 wherein the main flow tube has an outer diameter that is constant from the upstream port to the downstream port.

6. The connector of claim 1 wherein the upstream port has an outer diameter that is greater than an outer diameter of the downstream port.

7. The connector of claim 6 wherein the outer diameter contours gradually from the upstream port to the mixing channel.

8. The connector of claim 1 wherein the baffle projects into the main flow tube a distance less than half the inner diameter of the mixing channel.

9. The connector of claim 1 wherein the baffle comprises an outer wall substantially normal to main flow from the upstream port to the downstream port and configured to partially obstruct the main flow.

10. The connector of claim 9 wherein the outer wall comprises a semi-circular arch.

11. The connector of claim 9 wherein the outer wall comprises one or more substantially planar walls.

12. The connector of claim 11 wherein the outer wall comprises two substantially planar walls that meet along a leading edge of the baffle, the leading edge proximal to the upstream port.

13. The connector of claim 1 wherein the baffle comprises an inner wall having a contour aligned with a border of the inlet port.

14. The connector of claim 1 wherein the inlet port comprises a hole defined in an outer wall of the mixing channel oriented so that a central axis of the hole intersects at a right angle a central axis of the mixing channel.

15. The connector of claim 1 further comprising an inlet tube projecting from the inlet port to a connecting end.

16. The connector of claim 15 further comprising an anchoring flange connected to the inlet tube and displaced from the mixing channel by an insertion length, the anchoring flange projecting radially outward from the inlet tube.

17. The connector of claim 16 further comprising one or more anti-rotational locks disposed along a surface of the anchoring flange facing away from the mixing channel.

18. The connector of claim 16 wherein the inlet tube further comprises a tapered portion extending from a surface of the anchoring flange facing away from the mixing channel, the tapered portion having a maximum diameter at the anchoring flange.

19. The connector of claim 18 wherein the inlet tube further comprises a threaded portion extending from the tapered portion along an outer diameter of the inlet tube.

20. The connector of claim 19 wherein the inlet tube further comprises a clamping length and a tubing barb, the clamping length extending from the threaded portion to the tubing barb and the tubing barb terminating at the connecting end.

21. A method for providing a low flow, low pressure inlet for introducing supplemental fluid into a flow of main fluid, comprising:
immersing a treble-port venturi within the flow of main fluid to direct a portion of the main fluid flow through the venturi, the venturi having an upstream port, a mixing channel, and a downstream port, the upstream port having an inner diameter greater than an inner diameter of the mixing channel, the mixing channel having an inlet port for supplemental fluid;
connecting the inlet port to a supply of the supplemental fluid external to the main fluid flow; and
obstructing the portion of main fluid flow through the venturi upstream of the inlet port to create a separation zone adjacent to the inlet port.

22. The method of claim 21 further comprising maintaining pressure of the supplemental fluid greater than pressure in the separation zone.

23. The method of claim 21 further comprising maintaining pressure of the supplemental fluid (i) less than pressure in the main fluid outside the venturi and (ii) greater than pressure in the separation zone.

24. An inlet tube for introducing a supplemental fluid into main flow within a main flow conduit, comprising:
an insertion end having an outlet port and a baffle, the baffle forming a partial circumferential extension of the insertion end beyond the outlet port;
an anchoring flange displaced from the outlet port by an insertion length, projecting radially outward from a longitudinal axis of the inlet tube, and having a spike for anchoring the inlet tube to an inner wall of the main flow conduit, the spike disposed on a surface of the anchoring flange facing away from the insertion end; and
a connecting end extending from the surface of anchoring flange and terminating at an inlet port, the connecting end having a tapered circumferential portion adjacent to the surface of the anchoring flange, a threaded circumferential portion extending from the tapered circumferential portion, a clamping length extending from the threaded circumferential portion, and a tubing barb extending between the clamping length and the inlet port;
configured so that the insertion length positions the outlet port at an approximate center of the main flow when the inlet tube is anchored to the main flow conduit.
